(19) United States
(12) Patent Application Publication
(10) Pub. No.: US 2020/0013536 A1
(43) Pub. Date: Jan. 9, 2020

(54) REACTOR

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kazuhiro Inaba, Yokkaichi-shi, Mie (JP); Takemi Terao, Osaka-shi, Osaka (JP)

(21) Appl. No.: 16/492,216

(22) PCT Filed: Feb. 23, 2018
(86) PCT No.: PCT/JP2018/006787

§ 371 Date: Sep. 9, 2019

(30) Foreign Application Priority Data
Mar. 9, 2017 (JP) 2017-044634

(51) Int. Cl. H01F 27/24; H01F 37/00

(52) U.S. Cl. CPC H01F 27/24; H01F 37/00

(57) ABSTRACT

Provided is a reactor including a coil having a wound portion, and a magnetic core having an inner core portion arranged inside the wound portion and an outer core portion arranged outside the wound portion. The bottom surface portion, which is to be located on an installation side when the reactor is installed, of the outer core portion protrudes below the bottom surface of the inner core portion, the top surface portion on a side opposite to the bottom surface portion of the outer core portion protrudes above the top surface of the inner core portion, and the respective protrusion amounts are 20% or less of the height in a vertical direction of the inner core portion. The outer core portion has a shape that is symmetrical with respect to a center line that divides the inner core portion into an upper portion and a lower portion.

### CROSS-REFERENCE TO RELATED APPLICATIONS

This application is the U.S. national stage of PCT/JP2018/006787 filed on Feb. 23, 2018, which claims priority of Japanese Patent Application No. JP 2017-044634 filed on Mar. 9, 2017, the contents of which are incorporated herein.

### TECHNICAL FIELD

The present disclosure relates to a reactor.

### BACKGROUND

A reactor is one of the components used in a circuit that boosts/lowers a voltage. For example, JP 2011-119664A and JP 2009-246222A disclose a technique relating to a reactor including a coil and a magnetic core on which the coil is arranged. JP 2011-119664A and JP 2009-246222A state that an installation-side surface portion, which is to be located on an installation side when the reactor is installed, of an end core piece on which the coil is not arranged protrudes below an installation-side surface of a central core piece on which the coil is arranged, or a surface portion on a side opposite to the installation-side surface portion of the end core piece protrudes above a surface of the central core piece on a side opposite to the installation-side surface.

There is a demand for reducing vibration noise during driving of a reactor.

A reactor is driven by exciting a coil through the application of an electric current of a predetermined frequency to the coil. While being driven, the reactor may vibrate due to magnetostriction or electromagnetic attraction caused by the occurrence of a magnetic flux in a magnetic core, which may cause noise.

### SUMMARY

To address the problems described above, one of the objects of the present disclosure is to provide a reactor that can be reduced in size and can suppress vibration noise while being driven.

A reactor according to the present disclosure is a reactor including a coil having a wound portion; and a magnetic core having an inner core portion arranged inside the wound portion and an outer core portion arranged outside the wound portion. A bottom surface portion, which is to be located on an installation side when the reactor is installed, of the outer core portion protrudes below a bottom surface of the inner core portion. A top surface portion on a side opposite to the bottom surface portion of the outer core portion protrudes above a top surface of the inner core portion, and respective protrusion amounts are 20% or less of a height in a vertical direction of the inner core portion, and the outer core portion has a shape that is symmetrical with respect to a center line that divides the inner core portion into an upper portion and a lower portion.

### Advantageous Effects of the Present Disclosure

The reactor of the present disclosure can be reduced in size and can suppress vibration noise while being driven.

### BRIEF DESCRIPTION OF DRAWINGS

FIG. 1 is a schematic front view of a reactor of Embodiment 1.

FIG. 2 is a schematic plan view of the reactor of Embodiment 1.

FIG. 3 is a graph showing the relationship between the protrusion amount of an outer core portion and the natural frequency.

### DETAILED DESCRIPTION OF PREFERRED EMBODIMENTS

The inventors of the present disclosure focused on the relationship between the drive frequency of a reactor and the natural frequency of a magnetic core, and investigated the influence of the drive frequency on the vibration characteristics of the reactor. As a result, the following findings were obtained.

In cases of reactors used in power conversion devices to be mounted in hybrid automobiles and electric automobiles, the drive frequency of an electric current applied to coils is generally within a range of 5 kHz to 15 kHz and particularly a range of about 5 kHz to 10 kHz. If the natural frequency of the magnetic core is close to this drive frequency, resonance will occur and vibration noise will thus increase. In particular, if the drive frequency is within an audible range (generally 20 Hz to 20 kHz), the problem of vibration noise will manifest.

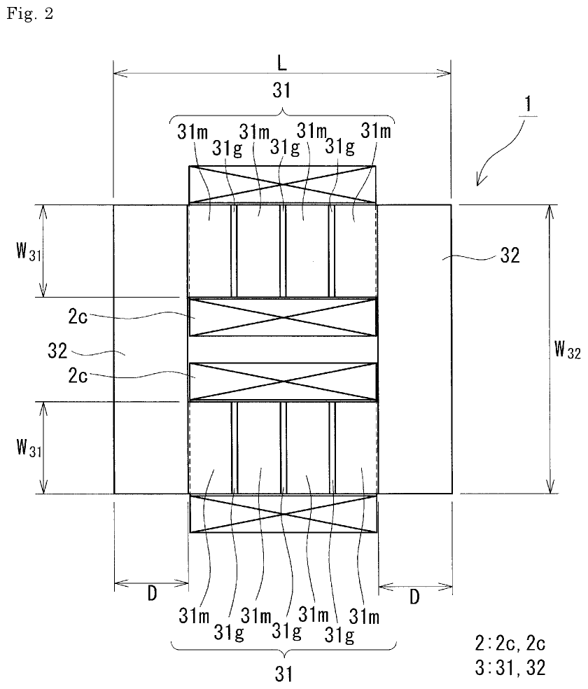

With the reactors disclosed in JP 2011-119664A and JP 2009-246222A, the magnetic cores have a configuration in which the bottom surface portion of the outer core portion located on an installation side protrudes below the inner core portion, or the top surface portion on a side opposite to the bottom surface portion protrudes above the inner core portion. Accordingly, with this configuration, compared with a magnetic core that has the same volume and has a configuration in which the outer core portion does not protrude from the inner core portion, the length in a direction extending in the axial direction of the coil can be reduced, and the projection area of the installed reactor in a plan view can thus be reduced, thus making it possible to reduce the size of the reactor (see paragraphs [0013], [0051] and the like in JP 2011-119664A and paragraphs [0014] and the like in JP 2009-246222A, for example). The reactors disclosed in JP 2011-119664A and JP 2009-246222A are basically configured such that at least a bottom surface side of the outer core portion protrudes, and when the outer core portion has a protrusion, the protrusion amount is set such that the protrusion is flush with the outer peripheral surface of the coil (see paragraphs [0039], [0061], FIG. 2(B), FIG. 5(A) and the like in JP 2011-119664A and paragraphs [0025], [0034], FIG. 2 and the like in JP 2009-246222A, for example).

The inventors of the present disclosure intensively investigated the vibration characteristics of conventional reactors as disclosed in JP 2011-119664A and JP 2009-246222A in which the outer core portion protrudes from the inner core portion. As a result, it was found that, compared with the case where the outer core portion does not protrude from the inner core portion, the natural frequency of the magnetic core was likely to decrease, and resonance occurred due to the natural frequency being close to the drive frequency, which resulted in an increase in vibration noise. As a result of intensive research, the inventors of the present disclosure found that the natural frequency decreased in the above-described conventional reactors mainly due to the protrusion amount of the bottom surface portion or top surface portion of the outer core portion being large relative to the inner core portion. In particular, it was found that, when the outer core portion was asymmetrical with respect to the center line that divides the inner core portion into an upper portion and a lower portion, the natural frequency was more likely to decrease.

Based on the above-mentioned findings, the inventors of the present disclosure recognized that it was important to suppress a decrease in the natural frequency in order to avoid resonance between the natural frequency of the magnetic core and the drive frequency, and devised the shape of the magnetic core to achieve the present disclosure.

First, embodiments of the disclosure of the present disclosure will be listed and described.

A reactor according to an aspect of the present disclosure is a reactor including a coil having a wound portion; and a magnetic core having an inner core portion arranged inside the wound portion and an outer core portion arranged outside the wound portion. A bottom surface portion, which is to be located on an installation side when the reactor is installed, of the outer core portion protrudes below a bottom surface of the inner core portion. A top surface portion on a side opposite to the bottom surface portion of the outer core portion protrudes above a top surface of the inner core portion, and respective protrusion amounts are 20% or less of a height in a vertical direction of the inner core portion, and the outer core portion has a shape that is symmetrical with respect to a center line that divides the inner core portion into an upper portion and a lower portion.

With the above-mentioned reactor, the bottom surface portion of the outer core portion protrudes below the inner core portion and the top surface portion thereof protrudes above the inner core portion, thus making it possible to reduce the length in a direction extending in the axial direction of the coil (wound portion) and reduce the projection area of the installed reactor. Accordingly, the footprint of the reactor is reduced, thus making it possible to reduce the size of the reactor. Furthermore, the protrusion amounts of the bottom surface portion and the top surface portion of the outer core portion are 20% or less of the height (i.e., the distance between the bottom surface and the top surface) of the inner core portion, thus making it possible to sufficiently suppress a decrease in the natural frequency of the magnetic core and make the natural frequency higher than the drive frequency (5 kHz to 15 kHz, or particularly 5 kHz to 10 kHz). Accordingly, resonance between the natural frequency and the drive frequency can be avoided by setting the natural frequency to be out of the drive frequency band. In addition, the outer core portion has a shape that is symmetrical with respect to the center line of the inner core portion, thus making it possible to effectively suppress the resonance. Therefore, resonance is less likely to occur, and vibration noise can be suppressed during driving of the reactor. Accordingly, the above-mentioned reactor can be reduced in size and can suppress vibration noise while being driven.

The protrusion amounts of the bottom surface portion and the top surface portion of the outer core portion are set to be 4% or more, or 8% or more, of the height of the inner core portion, for example, from the viewpoint of reducing the size of the reactor. On the other hand, the protrusion amounts are set to be 16% or less, 12% or less, or 10% or less, of the height of the inner core portion, for example, from the viewpoint of suppressing the vibration noise of the reactor.

The term “center line that divides the inner core portion into an upper portion and a lower portion” as used herein refers to an axis passing through the central position between the bottom surface and the top surface of the inner core portion. The term “symmetrical shape” satisfies the condition that the difference in the protrusion amounts between the bottom surface portion and the top surface portion of the outer core portion is 5% or less, and preferably 3% or less, of the height of the inner core portion.

In an embodiment of the above-mentioned reactor, a bottom surface and a top surface of the outer core portion are located on an inner peripheral side with respect to an outer peripheral surface of the wound portion of the coil.

When the bottom surface and the top surface of the outer core portion are located on the inner peripheral side with respect to the outer peripheral surface of the coil (wound portion), the height of the outer core portion is reduced. In this manner, the outer core portion can be reduced in height.

In an embodiment of the above-mentioned reactor, a natural frequency of the magnetic core is higher than a drive frequency.

Since the natural frequency of the magnetic core is higher than the drive frequency (e.g., 5 kHz to 10 kHz), the vibration noise can be suppressed. In particular, it is preferable that the natural frequency of the magnetic core is 10% or more higher than the drive frequency. For example, when the drive frequency is 10 kHz, the natural frequency is 11 kHz or more. In this case, the natural frequency of the magnetic core is sufficiently higher than the drive frequency, thus making it possible to significantly suppress the vibration noise. The natural frequency of the magnetic core is preferably higher than 10 kHz, and particularly preferably 11 kHz or more, for example, from the viewpoint of suppressing the vibration noise.

Hereinafter, specific examples of the reactor according to an embodiment of the disclosure of the present disclosure will be described with reference to the drawings. In the figures, components with the same name are denoted by the same reference numeral. The disclosure of the present disclosure is not limited to these embodiments and is defined by the scope of the appended claims, and all changes that fall within the same essential spirit as the scope of the claims are intended to be included therein.

### Embodiment 1

### Configuration of Reactor

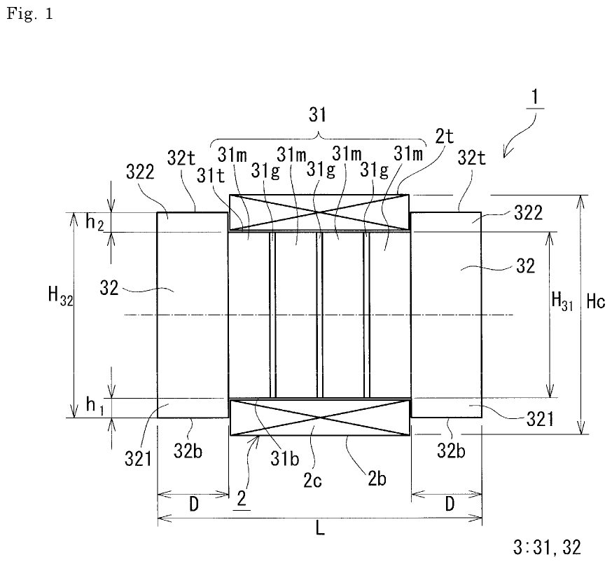

A reactor 1 of Embodiment 1 will be described with reference to FIGS. 1 and 2. As shown in FIG. 1, the reactor 1 of Embodiment 1 includes a coil 2 having wound portions 2c, and a magnetic core 3 having inner core portions 31 arranged inside the wound portions 2c and outer core portions 32 arranged outside the wound portions 2c. One of the features of the reactor 1 is that portions on a bottom surface 32b side of the outer core portions 32 protrude below bottom surfaces 31b of the inner core portions 31 and portions on a top surface 32t side of the outer core portions 32 protrude above top surfaces 31t of the inner core portions 31, and the protrusion amounts h₁ and h₂ of the portions on the bottom surface 32b side and the top surface 32t side of the outer core portions 32 are 20% or less of a height H₃₁ of the inner core portions 31.

The reactor 1 is installed to an installation target such as a converter case, for example. In this specification, the lower side of the reactor 1 (the coil 2 and the magnetic core 3 (the inner core portions 31 and the outer core portions 32)) in FIG. 1 serves as an installation side when the reactor 1 is installed. The installation side is taken as “lower side”, a side opposite to the installation side is taken as “upper side”, and the vertical direction is taken as the height direction. In addition, a direction extending in the axial direction of the inner core portions 31 (left-right direction in FIGS. 1 and 2) is taken as the longitudinal direction, and a direction that is orthogonal to both the height direction and the longitudinal direction (vertical direction in FIG. 2) is taken as the width direction. The configuration of the reactor will be described in detail below.

### Coil

As shown in FIG. 2, the coil 2 includes a pair of wound portions 2c obtained by winding a winding wire, and one end portion of one of the two wound portions 2c is connected to one end portion of the other via a coupling portion (not shown). The wound portions 2c are formed in a tubular shape by spirally winding a winding wire, and are arranged side-by-side (in parallel) such that their axial directions extend parallel to each other. Here, as shown in FIG. 2, the axial directions of the wound portions 2c correspond with the longitudinal direction, and a direction in which the wound portions 2c are lined up corresponds with the width direction.

The winding wire is a coated wire (so-called “enameled wire”) including a conductor (e.g., copper) and an insulating coating (e.g., polyamideimide) covering the outer periphery of the conductor. The coil 2 may be formed of a single continuous winding wire, or formed by joining one end portion of one of the two wound portions 2c to one end portion of the other through welding. The coil 2 (wound portions 2c) of this embodiment is an edgewise coil obtained by winding a coated flat wire in an edgewise manner, and the wound portions 2c are formed in a quadrilateral tube shape. As shown in FIG. 1, the outer peripheral surface of the coil 2 (wound portions 2c) includes a bottom surface 2b located on the installation side (i.e., lower side) and a top surface 2t located on a side opposite to the bottom surface 2b, and the distance in the vertical direction between the bottom surface 2b and the top surface 2t is taken as a height Hc.

### Magnetic Core

As shown in FIG. 2, the magnetic core 3 includes a pair of inner core portions 31 arranged inside the wound portions 2c and a pair of outer core portions 32 arranged outside the wound portions 2c. The inner core portions 31 are portions that are located inside the wound portions 2c arranged side-by-side and on which the coil 2 is arranged. That is, as in the case of the wound portions 2c, the inner core portions 31 are arranged side-by-side (in parallel) in the width direction such that their axial directions extend parallel to each other. The end portions of the inner core portions 31 in the axial direction may partially protrude from the wound portions 2c. The outer core portions 32 are portions that are located outside the wound portions 2c and on which the coil 2 is not substantially arranged (i.e., portions that protrude (are exposed) from the wound portions 2c). The magnetic core 3 is formed in an annular shape by arranging the outer core portions 32 so as to sandwich the inner core portions 31 from both sides and connecting the end surfaces of the inner core portions 31 to the opposing inner end surfaces of the outer core portions 32. When the coil 2 is excited through the application of an electric current, magnetic fluxes flow through the magnetic core 3, and a closed magnetic circuit is thus formed.

### Inner Core Portion

As shown in FIGS. 1 and 2, each of the inner core portions 31 includes a plurality of inner core pieces 31m and gaps 31g provided between the inner core pieces 31m. In this embodiment, each of the gaps 31g is constituted by a plate material made of a non-magnetic material such as a ceramic (e.g., alumina) or a resin (e.g., epoxy; including fiber reinforced plastic such as glass epoxy). The gaps 31g may be spaces (air gaps).

As shown in FIG. 1, the inner core portion 31 includes the bottom surface 31b located on the installation side and the top surface 31t located on a side opposite to the bottom surface 31b, and the distance in the vertical direction between the bottom surface 31b and the top surface 31t is taken as the height H₃₁ . The inner core portion 31 has a shape corresponding with the shape of the wound portion 2c. In this embodiment, the inner core portion 31 is a quadrangular column-shaped portion, and the inner core piece 31m is a quadrangular column-shaped piece. The inner core portion 31 has a configuration in which the gaps 31g are provided between the multiple inner core pieces 31m. In this embodiment, the number of inner core pieces 31m is four, and three gaps 31g are provided. It is sufficient that the number of inner core pieces 31m (gaps 31g) and the length of each gap 31g (each interval between the inner core pieces 31m) are set as appropriate such that a predetermined inductance can be obtained and desired magnetic characteristics can be ensured. It is sufficient that the gaps 31g including air gaps are provided as needed, but they do not necessarily have to be provided.

The inner core piece 31m is made of a material containing a soft magnetic material. Examples of the material for forming the inner core piece 31m include powder molded articles obtained by molding soft magnetic powder made of iron or an iron alloy (e.g., a Fe—Si alloy, a Fe—Si—Al alloy, or a Fe—Ni alloy), or coated soft magnetic powder that also includes insulated coatings, through compression molding, and composite materials containing soft magnetic powder and a resin. A thermosetting resin, a thermoplastic resin, a cold setting resin, or a low-temperature curing resin can be used as the resin for the composite material. Examples of the thermoplastic resin include polyphenylene sulfide (PPS) resin, polytetrafluoroethylene (PTFE) resin, a liquid crystal polymer (LCP), polyamide (PA) resin such as nylon 6 or nylon 66, polybutylene terephthalate (PBT) resin, and acrylonitrile-butadiene-styrene (ABS) resin. Examples of the thermosetting resin include unsaturated polyester resin, epoxy resin, urethane resin, and silicone resin. In addition, bulk molding compounds (BMCs) obtained by mixing calcium carbonate or glass fibers to unsaturated polyester, millable-type silicone rubber, millable-type urethane rubber, and the like can also be used. In this embodiment, the inner core piece 31m is constituted by a powder molded article.

### Outer Core Portion

As shown in FIGS. 1 and 2, the outer core portions 32 are arranged at the end portions on two sides of the inner core portions 31, and form the annular magnetic core 3 together with the inner core portions 31. In this embodiment, each of the outer core portions 32 is constituted by a single core piece having a block shape. That is, the magnetic core 3 is constituted by a plurality of core pieces, including the inner core pieces 31m constituting the inner core portions 31 and the core pieces constituting the outer core portions 32. As in the case of the inner core piece 31m, the outer core portion 32 is made of a material containing a soft magnetic material, and the above-described powder molded article or composite material can be used. In this embodiment, the outer core portion 32 is constituted by a powder molded article.

As shown in FIG. 1, the outer core portion 32 includes the bottom surface 32b located on the installation side and the top surface 32t located on a side opposite to the bottom surface 32b, and the distance in the vertical direction between the bottom surface 32b and the top surface 32t is taken as a height H₃₂. The portions on the bottom surface 32b side of the outer core portions 32 protrude below the bottom surfaces 31b of the inner core portions 31 and the portions on the top surface 32t side of the outer core portions 32 protrude above the top surfaces 31t of the inner core portions 31 (h₁, h₂>0). Specifically, each outer core portion 32 includes a lower protrusion 321 that protrudes downward with respect to the inner core portion 31 and an upper protrusion 322 that protrudes upward with respect to the inner core portion 31. The bottom surfaces 32b of the outer core portions 32 are located lower than the bottom surfaces 31b of the inner core portions 31, and the top surfaces 32t are located higher than the top surfaces 31t. That is, the height H₃₂ of the outer core portions 32 is larger than the height H₃₁ of the inner core portions 31 (H₃₂>H₃₁). The protrusion amounts h₁ and h₂ of the portions on the bottom surface 32b side and the top surface 32t side of the outer core portions 32 are 20% or less of the height H₃₁ of the inner core portions 31. Here, the protrusion amount h₁ of the portion on the bottom surface 32b side (lower protrusion 321) of the outer core portion 32 refers to the distance to the bottom surface 32b in the vertical direction with reference to the bottom surface 31b of the inner core portion 31. On the other hand, the protrusion amount h₂ of the portion on the top surface 32t side (upper protrusion 322) of the outer core portion 32 refers to the distance to the top surface 32t in the vertical direction with reference to the top surface 31t of the inner core portion 31 used as a baseline. Specifically, the protrusion amounts h₁ and h₂ of the outer core portion 32 are set such that the natural frequency of the magnetic core 3 is higher than the drive frequency of the reactor 1 (e.g., higher than 10 kHz).

In this embodiment, as shown in FIG. 1, the protrusion amount h₁of the portion on the bottom surface 32b side and the protrusion amount h₂ of the portion on the top surface 32t side of the outer core portion 32 are substantially the same, and the outer core portion 32 has a shape that is symmetrical with respect to the center line that divides the inner core portion 31 into an upper portion and a lower portion (axis passing through the central position between the bottom surface 31b and the top surface 31t). In FIG. 1, this center line is indicated by a dot-and-dush line. Moreover, the bottom surface 32b and the top surface 32t of the outer core portion 32 are located on the inner peripheral side with respect to the outer peripheral surfaces (the bottom surface 2b and the top surface 2t) of the wound portions 2c. Specifically, the bottom surfaces 32b of the outer core portions 32 are located higher than the bottom surface 2b of the wound portions 2c, and the top surfaces 32t are located lower than the top surface 2t. That is, the protrusion amounts h₁ and h₂ are smaller than the width (thickness) of the winding wire constituting the wound portions 2c, and the height H₃₂ of the outer core portions 32 is smaller than the height Hc of the wound portions 2c (H₃₂<Hc).

### TEST EXAMPLE 1

Vibration characteristics of a reactor having the same configuration as that of Embodiment 1 described above (see FIGS. 1 and 2) were evaluated. Here, a reactor 1 as shown in FIGS. 1 and 2 in which the protrusion amounts h₁ and h₂ of the outer core portions 32 were set to 0 was used as a reference model, and the vibration characteristics of models that varied in the protrusion amounts h₁ and h₂ were evaluated. The protrusion amounts h₁ and h₂ were set to be the same (h₁=h₂). In addition, the thickness D was varied (the width W₃₂ was constant) such that the volume of the outer core portion 32 remained the same even when the protrusion amounts h₁ and h₂ were varied. The vibration characteristics were evaluated through a CAE (Computer Aided Engineering) analysis using structural analysis software, and the natural frequency of the magnetic core was determined. A mesh for the CAE analysis was made of a hexa (hexahedral) mesh. In Test Example 1, an eigenvalue analysis and a frequency response analysis were performed using MSC Nastran (manufactured by MSC Software Corporation) as the structural analysis software, and a natural frequency of a vibration mode with expansion and contraction in the X direction (longitudinal direction) was determined as the natural frequency of the magnetic core.

The dimensions (mm) of the reference model were set as follows (see FIGS. 1 and 2).

Height of outer core portion (H₃₂): 42.0

Protrusion amount (h₁, h₂): 0

Thickness of outer core portion (D): 18.0

Width of outer core portion (W₃₂): 70.5

Height of inner core portion (H₃₁): 42.0

Width of inner core portion (W₃₁): 22.5

Length of magnetic core (L): 82.5

The thickness D was a distance in the longitudinal direction between the inner end surface of the outer core portion 32 and the outer end surface on a side opposite to the inner end surface.

The length L was a length in the longitudinal direction between one end and the other end of the magnetic core 3.

The width W₃₂ was a length in the width direction of the outer core portion 32.

The width W₃₁ was a length in the width direction of the inner core portion 31.

Materials for forming the magnetic core 3 and their characteristics were set as follows.

Core pieces (inner core pieces 31 m, outer core portions 32)
Material−Powder molded article
Characteristics−Young's modulus: 38500 MPa, Poisson's ratio: 0.25, Density: 7200 kg/m³

Gaps 3 g
Material—Ceramic
Characteristics—Young's modulus: 320000MPa, Poisson's ratio: 0.23, Density: 3700 kg/m³

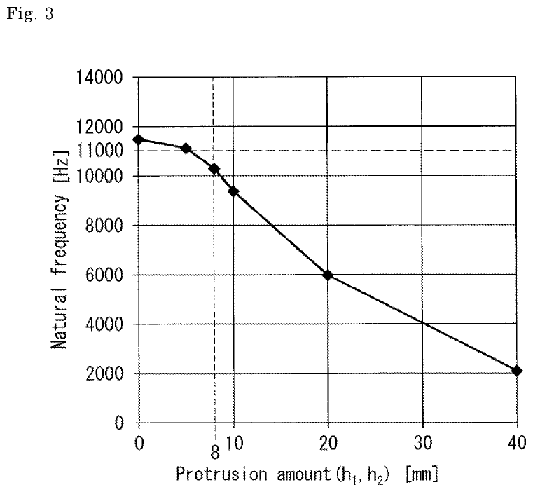

Under the above-mentioned conditions, the protrusion amounts h₁ and h₂ of the outer core portions 32 were varied, and the natural frequencies were determined through the CAE analysis. Table 1 and FIG. 3 show the results. In FIG. 3, the horizontal axis indicates the protrusion amounts h₁ and h₂ (mm) of the outer core portions 32, and the vertical axis indicates the natural frequency (Hz). Table 1 also shows the ratios (%) of the protrusion amounts h₁ and h₂ to the heights H₃₁ of the inner core portions 31, and the heights H₃₂ (mm), the thicknesses D (mm), and the lengths L (mm) for the various protrusion amounts h₁ and h₂ of the outer core portions 32.

TABLE 1

| Protrusion | | | | | |
|---|---|---|---|---|---|
| amounts | h₁, | Natural | | | |
| h₁, h₂ | h₂/H₃₁ | frequency | Height H₃₂ | Thickness D | Length L |
| (mm) | (%) | (Hz) | (mm) | (mm) | (mm) |
| 0 | 0 | 11487 | 42.0 | 18.0 | 82.5 |
| 5 | 11.9 | 11133 | 52.0 | 14.5 | 75.6 |
| 8 | 19.0 | 10303 | 58.0 | 13.0 | 72.6 |
| 10 | 23.8 | 9382 | 62.0 | 12.2 | 70.9 |
| 20 | 47.6 | 5990 | 82.0 | 9.2 | 64.9 |
| 40 | 95.2 | 2098 | 122.0 | 6.2 | 58.9 |

It is clear from the results shown in Table 1 that the larger the protrusion amounts h₁ and h₂ of the outer core portions 32 were, the smaller the thickness D of the outer core portions 32 was, and the length L of the magnetic core 3 could thus be reduced.

It is clear from the results shown in Table 1 and FIG. 3 that the larger the protrusion amounts h₁ and h₂ of the outer core portions 32 were, the lower the natural frequency was. When the protrusion amounts h₁ and h₂ were 10 mm or larger, the natural frequency decreased to 10 kHz or less. The natural frequency was within the drive frequency band (5 kHz to 10 kHz), and was thus close to the drive frequency of the reactor. Therefore, it is presumed that resonance will occur during driving of the reactor, and the vibration noise will thus increase. On the other hand, when the protrusion amounts h₁ and h₂ were 8 mm or smaller, the natural frequency was higher than 10 kHz. In this case, a decrease in the natural frequency was suppressed, and the natural frequency was higher than the drive frequency. This makes it possible to avoid resonance during driving of the reactor and to suppress the vibration noise. In particular, when the protrusion amounts h₁ and h₂ were 5 mm, the natural frequency was 11 kHz or more. In this case, a decrease in the natural frequency was sufficiently suppressed, and the natural frequency was sufficiently higher than the drive frequency. This makes it less likely that resonance will occur, thus making it possible to significantly suppress vibration noise. It is thought from these results that when the protrusion amounts h₁ and h₂ are about 8 mm or smaller (in other words, the ratios thereof to the height H₃₁ of the inner core portions 31 is 20% or less), a natural frequency of higher than 10 kHz can be realized.

### Functions and Effects

The reactor 1 of Embodiment 1 exhibits the following functions and effects.

Since the portions on the bottom surface 32b side and the top surface 32t side of the outer core portion 32 protrude from the inner core portion 31, the thickness D of the outer core portion 32 can be reduced in the case where the volume of the magnetic core is to remain the same, compared with the case where such portions do not protrude (h₁, h₂=0). Accordingly, the length L of the magnetic core 3 can be correspondingly reduced, and the projection area of the installed reactor 1 in a plan view can thus be reduced, thus making it possible to reduce the size of the reactor 1.

Since the protrusion amount h₁ and h₂ of the portions on the bottom surface 32b side and the top surface 32t side of the outer core portions 32 are 20% or less of the height H₃₁ of the inner core portions, and the outer core portion 32 has a shape that is symmetrical with respect to the center line of the inner core portion 31, a decrease in the natural frequency of the magnetic core 3 can be sufficiently effectively suppressed. Accordingly, the natural frequency can be made higher than the drive frequency of the reactor 1 (5 kHz to 10 kHz), and resonance between the natural frequency and the drive frequency can be avoided, thus making it possible to suppress the vibration noise during driving of the reactor.

The protrusion amounts h₁ and h₂ of the portions on the bottom surface 32b side and the top surface 32t side of the outer core portion 32 are set to be 4% or more, or 8% or more, of the height of the inner core portion, for example, from the viewpoint of reducing the size of the reactor. On the other hand, the protrusion amounts h₁ and h₂ are set to be 16% or less, 12% or less, or 10% or less, of the height of the inner core portion, for example, from the viewpoint of suppressing the vibration noise of the reactor.

### Application

The reactor 1 of Embodiment 1 can be favorably used in constituent components of various types of converters such as vehicle-mounted converters (typically DC-DC converters) to be mounted in vehicles including hybrid automobiles, plug-in hybrid automobiles, electric automobiles, fuel cell automobiles, and the like, and converters for an air conditioner, and constituent components of power conversion devices.

### Other Configurations

Other configurations of the reactor 1 are listed below.

An interposed member (not shown) located between the coil 2 and the magnetic core 3 may be provided. The interposed member is made of an electrical insulating material and ensures electrical insulation between the coil 2 and the magnetic core 3.

Examples of the above-mentioned interposed member include an inner-side interposed member (not shown) to be located between the inner peripheral surface of the wound portion 2c and the outer peripheral surface of the inner core portion 31, and an outer-side interposed member (not shown) to be located between the end surface of the wound portion 2c and the inner end surface of the outer core portion 32. The inner-side interposed member serves to position the inner core portion 31 inside the wound portion 2c and prevents the inner peripheral surface of the wound portion 2c from coming into contact with the outer peripheral surface of the inner core portion 31, thus ensuring the insulation therebetween. On the other hand, the outer-side interposed member prevents the end surface of the wound portion 2c from coming into contact with the inner end surface of the outer core portion 32, thus ensuring the insulation therebetween.

Examples of a material for forming the interposed member include thermoplastic resins such as PPS resin, PTFE resin, a liquid crystal polymer, PA resin such as nylon 6 or nylon 66, and PBT resin. The interposed member can be produced using a known method such as injection molding.

A case (not shown) in which an assembly of the coil 2 and the magnetic core 3 is accommodated may be provided. This makes it possible to protect the assembly from the external environment (dust, corrosion, and the like) and protect it mechanically. When the case is made of metal, its entirety can be used as a heat dissipation path, and therefore, heat generated in the coil 2 and the magnetic core 3 can be efficiently dissipated to the external installation target, thus improving the heat dissipation properties. Examples of a material for forming the case include aluminum and aluminum alloys, magnesium and magnesium alloys, copper and copper alloys, silver and silver alloys, iron, steel, and austenitic stainless steel. The weight of the case can be reduced when it is made of aluminum, magnesium, or an alloy thereof. The case may also be made of resin.

In the case where the assembly is accommodated in the case, sealing resin for sealing the assembly accommodated in the case may be provided. This makes it possible to electrically and mechanically protect the assembly and to protect the assembly from the external environment. Epoxy resin, urethane resin, silicone resin, unsaturated polyester resin, PPS resin, or the like can be used as the sealing resin. A ceramic filler having high thermal conductivity, such as alumina or silica, may be mixed into the sealing resin from the viewpoint of improving the heat dissipation properties.

A molded resin portion (not shown) molded on the assembly of the coil 2 and the magnetic core 3 may be provided. In this case, the assembly can be integrated using the molded resin portion. This also makes it possible to electrically and mechanically protect the assembly and to protect the assembly from the external environment even in the case where the assembly is not accommodated in the case. The molded resin portion can be formed of epoxy resin, PPS resin, PA resin, or the like, for example.

A heat dissipation plate (not shown) may be provided on at least one of the bottom surface 2b and the top surface 2t of the coil 2. This makes it possible to efficiently dissipate heat generated in the coil 2 to the external installation target, thus improving the heat dissipation properties.

1. A reactor comprising:
a coil having a wound portion; and
a magnetic core having an inner core portion arranged inside the wound portion and an outer core portion arranged outside the wound portion,
wherein a bottom surface portion, which is to be located on an installation side when the reactor is installed, of the outer core portion protrudes below a bottom surface of the inner core portion, a top surface portion on a side opposite to the bottom surface portion of the outer core portion protrudes above a top surface of the inner core portion, and respective protrusion amounts are 8% to 12% of a height in a vertical direction of the inner core portion,
the outer core portion has a shape that is symmetrical with respect to a center line that divides the inner core portion into an upper portion and a lower portion, and
a natural frequency of the magnetic core is higher than a drive frequency.

2. The reactor according to claim 1, wherein a bottom surface and a top surface of the outer core portion are located on an inner peripheral side with respect to an outer peripheral surface of the wound portion of the coil.

3. (canceled)

4. The reactor according to claim 1, wherein the coil has a pair of the wound portions, and
the magnetic core includes a pair of the inner core portions and a pair of the outer core portions.

5. The reactor according to claim 4, wherein each of the inner core portions and the outer core portions includes a core piece constituted by a powder molded article.

6. The reactor according to claim 4, wherein each of the inner core portions includes a plurality of core pieces and a gap provided between the core pieces,
each of the outer core portions is constituted by a single core piece, and
the core pieces are constituted by a powder molded article.
